(19) United States
(12) Patent Application Publication
(10) Pub. No.: US 2007/0233546 A1
(43) Pub. Date: Oct. 4, 2007

(54) SYSTEM AND METHOD FOR CONDUCTING BUSINESS TO OPTIMIZE CONSTRUCTION SITE PERFORMANCE

(76) Inventors: William T. Guevremont, Groton, CT (US); Warren L. Sepolen, West Hartford, CT (US)

Correspondence Address: KELLEY DRYE & WARREN LLP, 400 ALTLANTIC STREET , 13TH FLOOR, STAMFORD, CT, 06901, US

(21) Appl. No.: 11/686,907

(22) Filed: Mar. 15, 2007

Related U.S. Application Data
(60) Provisional application No. 60/782,845, filed on Mar. 16, 2006.

(51) Int. Cl. G06Q 10/00; G06F 15/02; G06F 9/46

(52) U.S. Cl. 705/9; 705/1

(57) ABSTRACT

A system and method for conducting business to optimize the performance of construction project agreements to the benefit of an owner and a manufacturer. An agent enters into business arrangements with entities involved in a construction project in order to provide manufacturer product pricing to an owner, while increasing the manufacturer's overall market share in the particular project.

### CROSS-REFERENCE TO RELATED APPLICATIONS

This application claims priority of U.S. Provisional Patent Application Ser. No. 60/782,845 filed Mar. 16, 2006, the entire contents of which are incorporated herein by reference in their entirety.

### BACKGROUND OF THE INVENTION

The present invention relates generally to a system and method for conducting business to increase financial opportunities associated with large scale construction projects. More particularly, the present invention relates to a system and method for conducting business for creating increased revenue streams from current construction project business arrangements.

A present day construction project necessarily includes a myriad of business arrangements at every stage of the project. From the very beginning of any construction project, business arrangements are required. Beginning with the owner of the job site, the owner must first arrange to purchase any property that he or she intends to develop. A real property purchase includes many individual agreements, including but not limited to an owner (in this transaction as the buyer)-surveyor, owner-agent agreement, owner-attorney agreement, owner-title agent agreement, seller-agent agreement and a seller-attorney agreement. In some cases there are owner-engineering agreements to inspect structures on the property, the systems, or both, within the structure.

In the event an owner wants to develop land many additional agreements with many different entities are then required. In a typical land development project the number of business arrangements may run into the hundreds. For large projects that number may inflate into the thousands.

For example, in a typical 20 story building project there are literally thousands of products that must be designed, manufactured, ordered, packaged, delivered, stored and installed. The products necessary for construction range from structural materials such as concrete, steel and wood to systems products such as electrical wiring, receptacles and switches, network materials and windows, to cosmetic products such as flooring materials, carpets, lighting, bathroom fixtures, tables, chairs, railings and many other products.

For each job there is typically an owner hired architect or engineer (“A/E”) that designs the building with each necessary product in mind as to how each product may work within the design.

Currently, product manufactures rarely have an opportunity to communicate with the A/E about advantageously positioning its products within any particular job site. Owner's typically hire general contractors or construction managers (“GC/CM”) to handle the day to day operations of assembling a building. This task is typically administratively heavy because the GC/CM must manage every aspect of the construction project, from breaking ground with the first shovel, to setting the foundation, to assembling the floors to applying the finishing touches. In some cases the GC/CM will not be released from his or her obligations to the owner before a “walkthrough”, where the owner, or his representative, actually walks the grounds and approves of the construction. This process likely includes a series of steps that associate local governmental building inspectors that monitor and track the progress of the construction site to ensure that a structure is being assembled according to the local building codes and the Contract Documents.

Because the actual construction of a building involves many different trades and requires a delicately planned and carefully executed choreograph of events, the GC/CM typically enters into agreements with subcontractors to perform certain construction tasks. These subcontractors are typically tasked with the actual construction of each individual element or system for the building. In addition, the GC/CM duties to oversee the project may include that he or her request that, subcontractors not only perform the actual construction of the building elements, they may also require the subcontractors to provide the building materials as specified by the owner or A/E. In order to provide materials, subcontractors likely visit a local or affiliated distributor of products that are in the subcontractor's particular trade. For example, a plumber hired to provide and install A/E specified plumbing into the building will likely visit a local plumbing distributor and order a certain amount of product in order comply with the subcontractors agreement with the GC/CM.

In turn the distributor will likely place orders with a particular manufacturer in order to supply the subcontractor with enough material for the assigned project. As such, the manufacturer is often quite removed from the owner, the A/E or both. In some cases, the owner or A/E may request or demand a certain manufacturer's products but because of cost issues the owner or the A/E will likely accept any product that accomplishes the specific design requirements for any particular job.

Working with the current business model for construction projects a typical manufacturer can expect to garner a certain percentage of revenue by the very nature of making its products available. Manufacturers are typically not in the business of close marketing its products to owners or A/Es simply because the incentive to do so has not existed. Manufacturers and their distributors more often direct sales to subcontractors rather than directly to owners or A/Es. Most manufacturers are content to receive their expected share of a building project under the current system without asserting much effort to do so.

In this connection, it has been found that some manufacturers lack the communication, or more likely, any incentive to initiate communication with the owners or A/E so their products are considered initially with the product flows, design flows and concepts developed by the owner or the A/E on behalf of the owner. The current business model mandates that the individual product orders flow from the GC/CM to the subcontractor to the distributor and then to the manufacturer. It has been found that an A/E will likely develop the specifications for projects and frequently recommend familiar or personally favored brand names or recognized names to be included in a construction project.

Nevertheless, in the face of this increased competition in an increasingly global market manufacturers are seeking an avenue to increase their market share, or at least to maintain the current levels. Some manufacturers have taken to conduct market research and development and will cater and market their materials to certain subcontractors and distributors. Subcontractors may, in turn, offer these products as alternatives to the basic A/E design specifications and they will frequently request changes in those specifications for substituting materials.

As such, the current business model acts as an impediment to a manufacturer's attempt to advantageously position its products in front of an owner or an A/E in order to increase its presence within a particular project.

This is because the above-described business model unfortunately includes large price markups for each product that is involved. For example, in connection with the plumbing of the building, by the time the product actually arrives at the job site, the manufacturer's price for any particular product has likely been significantly increased. Each layer the manufacturer is removed from the owner and the A/E typically adds a two or three fold price increase. This is a very large percentage of the owner paid cost that the manufacturer is not capturing.

Moreover, the owner is paying substantially higher prices over the manufacturer's cost for the products. This process is repeated all across the job site for each individual product required for the building and across the many different trades necessary for the project. As such the cost of working within the current business model to an owner is extremely high. For the manufacturer, the potential lost revenue due to the current business model is also high.

Other problems encountered by the owner, in addition to inflated costs, include cost overruns, and change-orders. These additional costs frequently are attributed to changes in availability of product, shortage of product, compromised quality as specified in a contract or during the conceptual development phase.

Within all the activity surrounding a construction project there is typically an agreed upon schedule of milestones. A product is designed, ordered and scheduled for delivery based upon its manufacture characteristics, time required for installation and its location within a building. This choreographed effort necessarily includes many financial arrangements with various business terms to direct funds from the owner, to the GC/CM, to the subcontractors, the distributors and the manufacturer. Delays at the construction site can be costly for the owner. Owner-A/E miscommunication or misunderstanding during the conceptual or design phase may contribute to frequent product change orders and cost-overruns and unnecessary products. Each change in a design specification calling for a certain product typically must be directed to the GC/CM, through the subcontractors and the product distributors and eventually to the manufacturer. Each product design change post construction start-up typically experiences a disproportionately high mark up due to tightly choreographed schedule of a particular building. If a design is changed with a short time to get the product to the job site costs are typically ten fold for any particular product.

Furthermore, it has been found that to increase personal profitability some GC/CMs, subcontractors, or both, may attempt to substitute non-A/E specified materials for those designed by the A/E that include a manufacturer's product. This may cause lost sales to the manufacturer, generate a conflict with the A/E, delay triggers for loan payments and ultimately contribute to delays in the construction process in turn increasing the costs of the project to the owner. Any disruption to the carefully choreographed construction schedule typically translates into delays and increase costs for the owner. Furthermore, public knowledge of missed deadlines, construction milestones or payments to a lender, the GC/CM, subcontractor or distributor may also negatively affect the reputation of the owner.

Another owner issue arises with respect to surplus materials. Typically the subcontractor will include an exemplary order for materials as part of his or her bid to the owner for the project. It has been found that in most cases surplus materials will exist after completion of the particular job handled by the subcontractor. In many cases the subcontractor may, unknown to the owner, order more materials than necessary and keep the surplus materials for future use and markup on subsequent projects. It is an uncommon event that those surplus materials will be routed back to the distributor for restocking and so therefore, there's a lost opportunity for the owner of the project to recoup costs on surplus materials.

Therefore, what is needed is a system and method of conducting business to optimize construction project agreement implementing accounting and procurement procedures directed by the manufacture to the benefit of the owner.

### SUMMARY OF THE INVENTION

The present invention includes a system and method for conducting business to optimize strategic construction industry business relationships to the benefit of manufacturers and owners.

In a first aspect, the present invention includes a method for optimizing the performance of construction projects for an owner of a job site, the method including securing at least one business arrangement with a manufacturer, where the at least one arrangement contains owner favorable terms in connection with products or services related to the construction project.

In some embodiments at least one business arrangement is secured with the general contractor or construction manager. Further, the present embodiment includes securing at least one business arrangement with the owner and determining owner specifications for the job site. A first price point for at least one manufacturer product is determined and agreed upon where the owner specifications are compared with the at least one manufacturer product or service prices. A second price point is set, where the second price point is established based upon first set of pre-determined criteria and where the second price point is at or below said first price point. At least one customized product is provided, where the at least one customized products is customized based upon a second set of predetermined criteria. The at least one customized product is ordered from a manufacturer specified vendor/distributor and a schedule is set for the delivery of the at least one customized product to the job site based upon a comparison of the owner's specifications and manufacturer product. In addition onsite inventory control is conducting of the delivered at least one customized product.

Some embodiments securing a business arrangement with a job site insurance broker. The first set of predetermined criteria includes the nature of products and services, quantities, qualities and availability. The second set of predetermined criteria includes the comparison of original owner specifications and the owner favorable terms and the first and second price points.

The owner specifications are determined for the job site by creating the specifications based upon the at least one manufacturer product. In some embodiments, determining owner specifications for the job site further includes creating the specifications based upon the at least one insurance product.

### BRIEF DESCRIPTION OF THE DRAWINGS

While the specification concludes with claims particularly pointing out and distinctly claiming the present invention, it is believed the same will be better understood from the following description taken in conjunction with the accompanying drawings, which illustrate, in a non-limiting fashion, the best mode presently contemplated for carrying out the present invention, and in which like reference numerals designate like parts throughout the Figures, wherein:

FIG. 1A shows a prior method of conducting business model process flow for a construction project;

FIG. 1B shows a prior method of conducting business model product flow for a construction project;

FIG. 2 shows a method of conducting business model process flow according to one embodiment of the invention;

FIG. 3 shows a method of conducting business model process flow according to another embodiment of the invention; and

FIG. 4 shows a method of conducting business according to one embodiment of the present invention.

### DETAILED DESCRIPTION OF THE PREFERRED EMBODIMENTS

The present disclosure will now be described more fully with reference to the Figures in which an embodiment of the present disclosure is shown. The subject matter of this disclosure may, however, be embodied in many different forms and should not be construed as being limited to the embodiments set forth herein.

The present invention advantageously packages the cost savings opportunities from material procurement and insurance cost savings by creating networked arrangements between manufacturers, owners and insurance brokers which could not have been implemented in prior art systems. The present invention further combines the key elements of material procurement, increased market shares for manufactures and insurance brokers by exposing wholesale pricing options with reduction of the contractor mark-up costs. By reducing the “contractor mark-up costs” and utilizing, manufacture wholesale pricing owners could potentially save a large amount of money on the construction costs while increasing the market shares for the manufacturer.

The present invention implements commercial business arrangements that direct the construction process using the traditional subcontractor/distributor-supplier model and yet allows owners that ability to supply their own materials at a competitive price. By offering direct discounts opportunities where appropriate, owners may preselect purchases of construction commodities from a single source and receive discounts based on type of material, quantity, quality and availability. Advantageously, manufacturers may offer discounts with the objective to increase volume of sales as there may be a direct relationship between volume of sales and customer discounts. In addition, the present invention could also decrease owner construction costs as it will control cost over runs during construction since contractors can base profits on change orders.

The present invention includes developing strategic business alliances with key industries to open and develop opportunities that are specifically directed toward owners and developers to allow manufucturers to be directly involved in the design phase of the construction project.

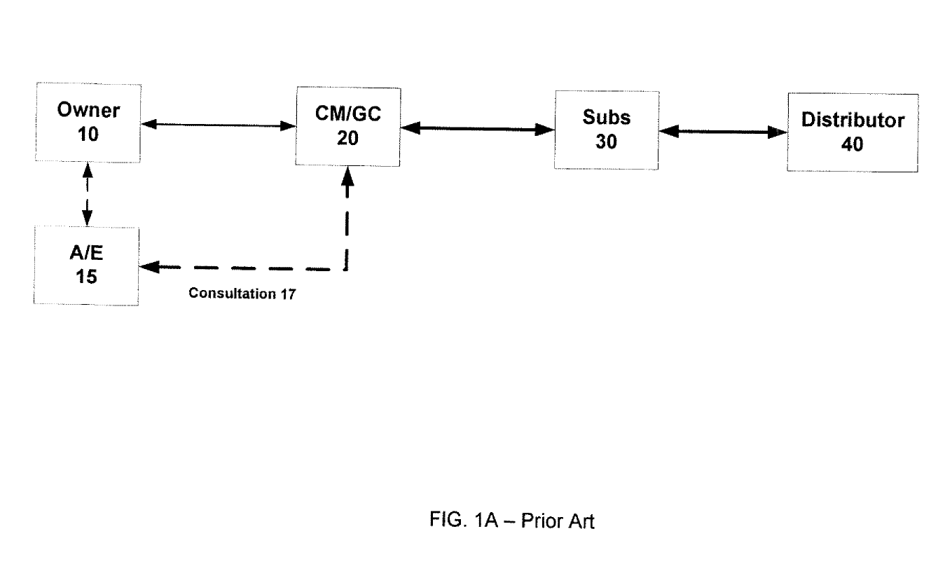

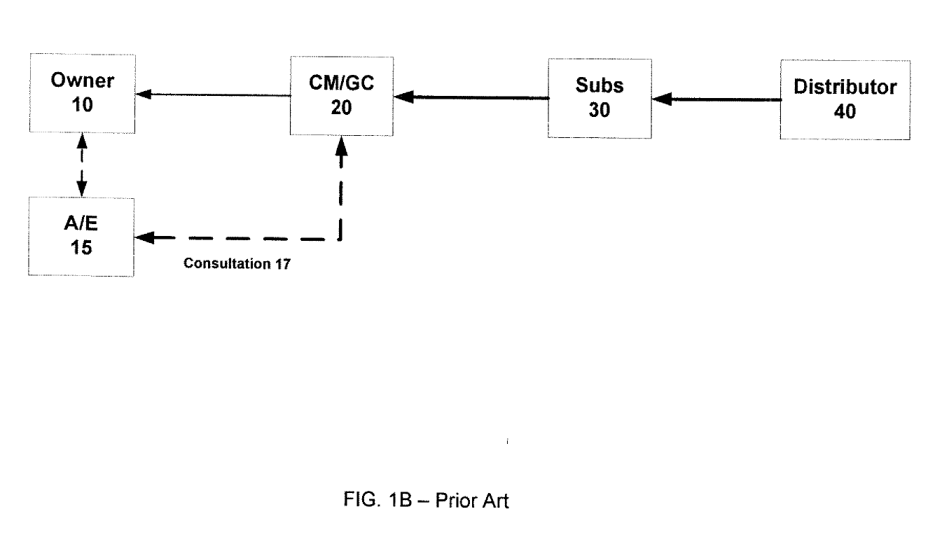

Referring now to FIG. 1A there is shown the prior system and method of conducting business. In the traditional process flow diagram owner 10 determines the nature of the project, typically starting with the conceptual and design input determining budget for the project, and then will proceed to solicit bids for general contractors to bid on the project based on their estimates. In planning the project owner 10 will enter into a business arrangement with GC/CM 20. Once that agreement has been awarded for the project, GC/CM 20 then coordinates and implements and develops a project schedule. The project schedule includes established milestone dates, completion dates and payment dates. GC/CM 20 will then request bidding from at least two subcontractors 30 for each individual phase of the project.

The design of the project is provided to the subcontractor for implementation which will mean a comprehensive review of those specifications, diagrams, drawings and those milestones generated by the GC/CM 20. Subcontractors 30 may offer bids for the project that may include labor and material. Once the subcontractors 30 have been retained, they will, in turn, purchase material through a distributor 40. The distributor then typically receives a percentage mark-up of the manufacturer purchase prices. The mark-up can be 30%, 40%, 50% or higher depending on the negotiated price for product used during the entire project. The distributor then procures the desired product from various manufacturers.

Another component would be the A/E 15, architect and engineer feedback. The A/E 15 continually consults with the owner 10 (flow 15) and the GC/CM 20 (flow 17) throughout the construction period to address changes or modifications of those specifications in the field.

In FIG. 1B, there is shown a prior system and method of conducting business for the traditional product flow diagram. The flow of products in the prior art system begins with distributor 40, which forwards the products to subcontractors 30. In turn, the subcontractors 30 deliver the products to the GM/CM 20 and eventually the job site owner 10. At each point the costs of the products are marked up, in some cases two, three or more times over manufacturer 45 prices.

The A/E 15 also continually consults with the owner 10 (flow 15) and the GC/CM 20 (flow 17) throughout the construction period to address changes or modifications of those products in the field.

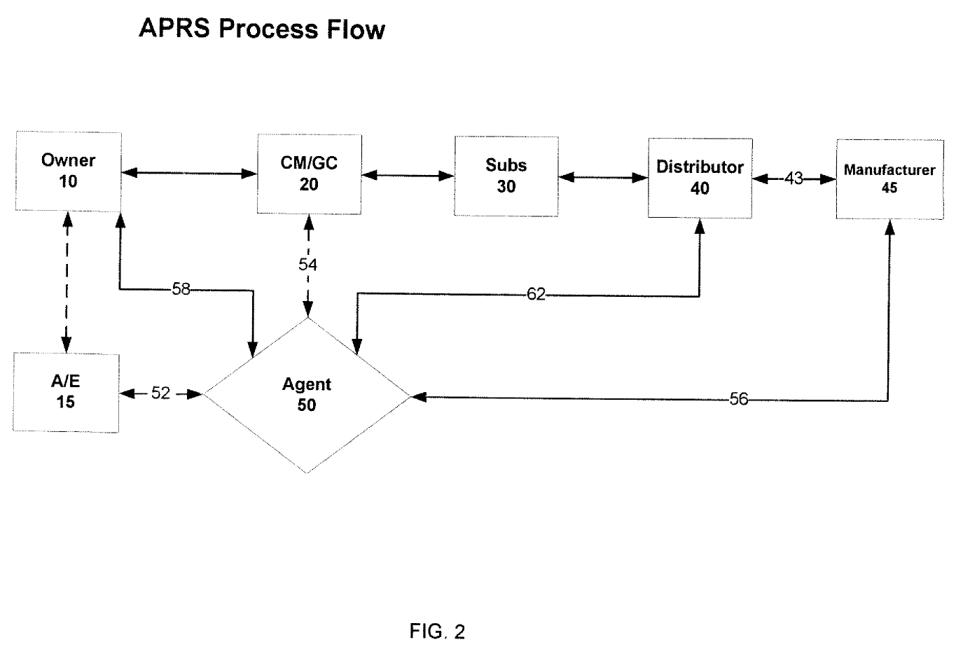

Referring now to FIG. 2 where an embodiment of the present invention is shown, owner 10 may still enter into business arrangements a GC/CM 20. GC/CM 20 may also continue to enter into agreements with subcontractors 30, and subcontractors 30 may also continue to enter into business arrangements with distributors 40. Advantageously, agent 50 may enter into business relationships 56 directly with manufacturer 45 and enter into a business arrangement 58 directly with the owner 10. In addition, in order to maintain as much stability as possible with the prior art system, agent 50 may also enter into agreements or communicate with GC/CM 20 (flow 54) and the A/E 15 (flow 52). Flow 54 and 52 are preferably negotiated or directed by owner 10 or according to the instructions of owner 10. Agent 50 preferably uses its business relationships 58 and 56 to the benefit of the owner 10 to provide low cost products of the manufacturer 45 directly to the job site. As such, manufacturer 45 can optimize its product position within the A/E 15 design and increase its overall share of the project while owner 10 receives the benefit of the low manufacturer prices.

As part of business arrangement 56, Agent 50 and manufacturer 45 enter in to an agreement regarding a range of price points for a particular product as specified by the A/E 15. Manufacturer 45 will then enter into a business arrangement 43 with distributor 40 for the sale of the product at a price no higher than the price point agreed by agent 50 and manufacturer 45 via arrangement 56.

Upon notification from manufacturer 45 that business arrangement 43 has been entered into, agent 50 will enter into business arrangement 62 with distributor 40 for the sale of additional manufacturer 50 products. In some cases, business arrangement 62 will require distributor 40 to deliver manufacturer 40 products to agent 50. In this case agent 50 will deliver the manufacturer 40 products to the GC/CM 20 or directly to the owner 10. In other cases business arrangement 62 requires distributor 40 to deliver the manufacturer 40 products directly to owner 10. In this way, owner 10 will receive manufacturer 40 products from distributor 40 at costs that are substantially reduced when compared to the prior system. In addition, manufacturer 40 will sell products through this novel system and method conducting business that they otherwise would not have sold.

As a distinction in this particular process flow, the subcontractor 30 does not own or deliver the material. Agent 50 may also have increased roles on the jobsite, for example to protect the interest of the owner to monitor proper arrival, storage and security of product purchased and owned by the owner. Subcontractor 30 will provide labor only and hence the risk of product loss is reduced further increasing owner 10 savings. In some embodiments, agent 50 may enter into an agreement with subcontractors 30 where agent will deliver or have delivered to subcontractors 30 the products from manufacture 45.

Advantageously in the present invention manufacturer 45 may maintain its own distribution network with distributors 40 and retain its customary expected market share for any particular project while garnering an increased share of the market without additional marketing efforts or internal associated costs. Further, manufacturer 45 will benefit with a greater role because they are directly communicating with and providing input to their distributors.

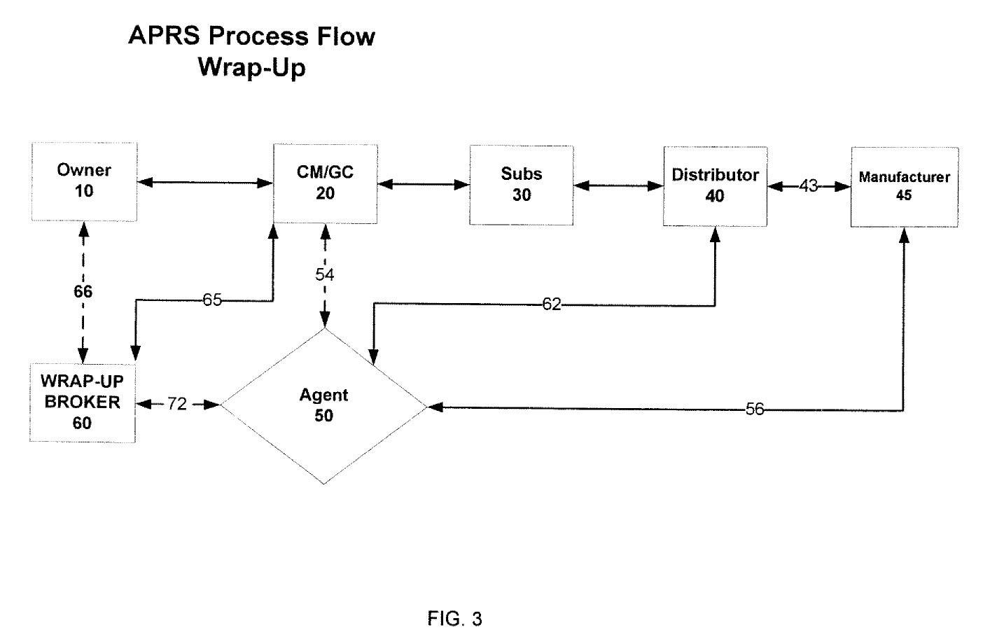

Referring now to FIG. 3 there is shown a process flow wrap up according to one embodiment of the invention. This embodiment advantageously includes insurance broker 60 in a business arrangement 72 with agent 50.

Broker 60 typically floats insurance agreements related to the wrap up of the job site to address the worker compensation and general liability coverage is for a particular jobsite. The value of insurance represents approximately three (3) percent of the total construction project budget.

There may also be communication 65 between broker 60 and GC/CM 20. Communication 65 typically exists because of the hands-on, aggressive posture of broker 60 in that they exercise control activity in the day-to-day operation and monitoring of the jobsite. The broker 60 therefore has a greater interest and involvement in the project, particularly with any claims handling. Brokers 60 are typically interested in the security and theft and bonding exposures on the jobsite as a result because it is an insurable interest.

Business arrangements 66 and 72, which were not allowable under the prior art, provides an opportunity for broker 60 to increase its market share and its value added to owner 10. Additionally, the owner 10 has an opportunity in this embodiment of the present invention which is not been provided heretofore in the prior art. Namely, owner 10 has direct consultation with agent 50 monitoring the use, security and quality control of the products used on their jobsite, to their sole benefit. It has been found that this embodiment is particularly well suited for construction projects valued $100 million and large.

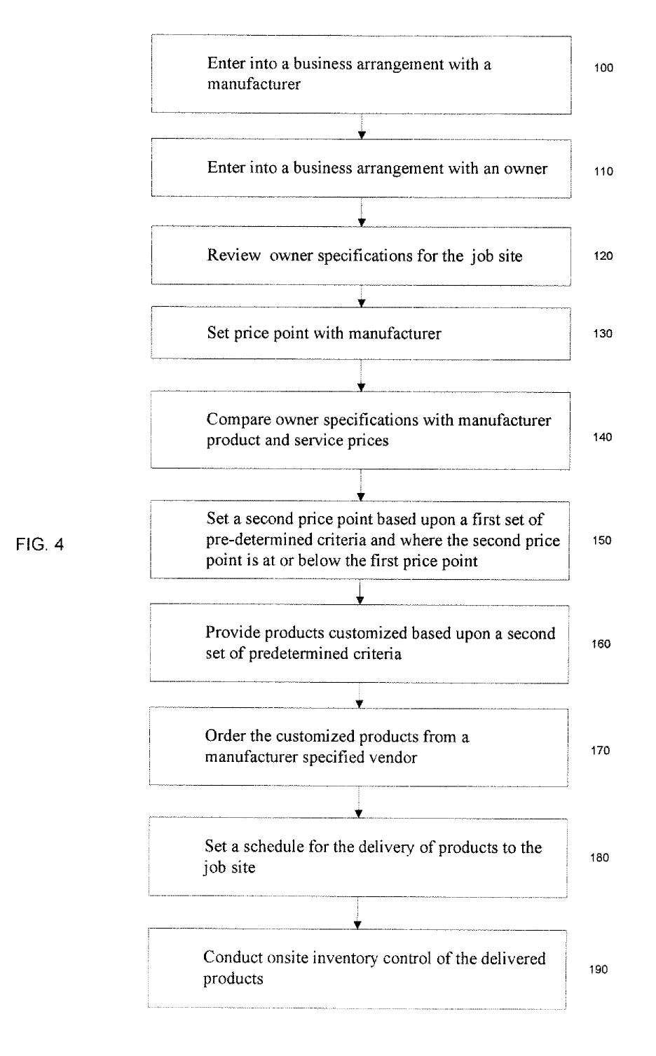

Referring now to FIG. 4 there is shown a flow diagram according to one embodiment of the invention. Agent 50 enters into at least one business arrangement 100 with a manufacturer 45, where the at least one arrangement contains owner 10 favorable terms in connection with products or services related to a construction project. Agent 50 may also enter into an agreement with owner 10 of the construction site 110 and determine the specifications of the job site 130 as discussed by the owner 10 and the A/E 15. Agent 50 and manufacturer 45 agree to a price point for a manufacturer product, where agent 50 will compare 140 the owner 10 or A/E 15 design specifications with the manufacturer 45 product price. Manufacturer 45 will enter into an agreement with distributor 40 and set second price point 150, where said second price point is established based upon first set of predetermined criteria and where said second price point is at or below said first price point. Manufacturer 45 will provide the customized product, where the at least one customized products is customized based upon a second set of predetermined criteria 160. The customized product is ordered 170 preferably from a manufacturer specified vendor and preferably by agent 50. In some cases owner 10 or even A/E 15 may order the customized products. The first set of predetermined criteria may include the nature of products and services, quantities, qualities and availability. The second set of predetermined criteria may include the comparison of original owner specifications and the owner favorable terms and the first and second price points.

A delivery schedule is set 180 for the customized products to arrive at the job site based upon a comparison of the owner 10 or A/E 15 design specifications and manufacturer 45 products. Preferably, agent 50 will be conducting onsite inventory control of the delivered customized products 190.

It will be apparent to one of skill in the art that described herein is a novel system and method for conducting business to optimize construction site performance. While the invention has been described with reference to specific preferred embodiments, it is not limited to these embodiments. The invention may be modified or varied in many ways and such modifications and variations as would be obvious to one of skill in the art are within the scope and spirit of the invention and are included within the scope of the following claims.

What is claimed is:

1. In a construction project involving an owner, a contractor, and manufacturers of products to be used in the construction project, a method comprising the steps of;
(a) contacting said manufacturers to determine a price for said products to be used in construction project,
(b) obtaining said products from one or more of said contacted manufacturers for use in said construction project,
(c) contacting said contractor to cause said construction project to be completed with said obtained products.

2. The method of claim 1 wherein the product obtained in step (b) is obtained at a price below that charged by the manufacturer for a single order.

3. The method in claim 1 where the contacting in step (a) is performed by the owner.

4. The method in claim 1 where the contacting in step (a) is performed by a purchasing agent hired by the owner.

5. The method in claim 1 where step (b) is performed by the owner.

6. The method in claim 1 where step (b) is performed by a purchasing agent hired by the owner.

7. The method in claim 1 where the products in step (c) are products selected from a group consisting of at least one of: concrete, steel, wood, electrical wiring, receptacles, switches, network materials, plumbing materials, heating systems, ventilation systems, air conditioning systems, insulation, materials, windows, flooring materials, lighting, bathroom fixtures, tables, chairs, and railings.
